(19) United States
(12) Patent Application Publication
(10) Pub. No.: US 2025/0346185 A1
(43) Pub. Date: Nov. 13, 2025

(54) CONTROLLER, DISPLAY SYSTEM, AND DISPLAY METHOD

(71) Applicant: DENSO CORPORATION, Kariya-city (JP)

(72) Inventors: MICHIHIRO TAKADA, Kariya-city (JP); SHINICHI MORIYAMA, Kariya-city (JP)

(21) Appl. No.: 19/201,198

(22) Filed: May 7, 2025

(30) Foreign Application Priority Data
May 13, 2024 (JP) 2024-078080

(51) Int. Cl. B60R 1/26; B60R 1/00; B60R 1/27

(52) U.S. Cl. CPC B60R 1/26; B60R 1/003; B60R 1/27; B60R 2300/105; B60R 2300/607

(57) ABSTRACT

A controller includes a state determination unit and an image generation unit. The state determination unit determines whether a vehicle is in a towing state. The image generation unit generates a bird's eye view image from surrounding images of a surrounding area of the vehicle, and display the bird's eye view image on a display. The bird's eye view image includes a first bird's eye view image and a second bird's eye view image. The surrounding area in the second bird's eye view image is larger than the surrounding area in the first bird's eye view image. The image generation unit displays the first bird's eye view image upon the state determination unit determining that the vehicle is not in the towing state, and displays the second bird's eye view image upon the state determination unit determining that the vehicle is in the towing state.

### CROSS REFERENCE TO RELATED APPLICATION

The present application claims the benefit of priority from Japanese Patent Application No. 2024-078080 filed on May 13, 2024. The entire disclosure of the above application is incorporated herein by reference.

### TECHNICAL FIELD

The present disclosure relates to a controller, a display system, and a display method.

### BACKGROUND

There is a surrounding monitoring device. The surrounding monitoring device generates a bird's eye view image and displays a generated image on a display device.

### SUMMARY

A controller disclosed herein includes a state determination unit and an image generation unit. The state determination unit is configured to determine whether a vehicle is in a towing state where the vehicle tows a towed object. The image generation unit is configured to generate a bird's eye view image from surrounding images of the surrounding area that are captured by multiple cameras, and display the bird's eye view image on a display. The bird's eye view image shows the vehicle and the surrounding area. The bird's eye view image includes a first bird's eye view image and a second bird's eye view image. The surrounding area in the second bird's eye view image is larger than the surrounding area in the first bird's eye view image. The image generation unit is further configured to display, on the display, the first bird's eye view image upon the state determination unit determining that the vehicle is not in the towing state, and display, on the display, the second bird's eye view image upon the state determination unit determining that the vehicle is in the towing state.

A display system disclosed herein is a display system used in a vehicle. The display system includes multiple cameras that are configured to capture a surrounding area of the vehicle, and a controller. The controller includes a state determination unit and an image generation unit. The state determination unit is configured to determine whether the vehicle is in a towing state where the vehicle tows a towed object. The image generation unit is configured to generate a bird's eye view image from surrounding images of the surrounding area that are captured by the multiple cameras, and display the bird's eye view image on a display. The bird's eye view image shows the vehicle and the surrounding area. The bird's eye view image includes a first bird's eye view image and a second bird's eye view image. The surrounding area in the second bird's eye view image is larger than the surrounding area in the first bird's eye view image. The image generation unit is further configured to display, on the display, the first bird's eye view image upon the state determination unit determining that the vehicle is not in the towing state, and display, on the display, the second bird's eye view image upon the state determination unit determining that the vehicle in the towing state.

A display method disclosed herein is used in a vehicle. The method includes acquiring surrounding images of a surrounding area around the vehicle that are captured by multiple cameras and determining whether the vehicle is in a towing state where the vehicle tows a towed object. The display method includes, upon determining that the vehicle is not in the towing state, generating a first bird's eye image of the vehicle and the surrounding area from the surrounding images, and displaying the first bird's eye view image on a display. The display method includes, upon determining that the vehicle is in the towing state, generating a second bird's eye view image of the vehicle and the surrounding area from the surrounding images, and displaying the second bird's eye view image on the display. The surrounding area in the second bird's eye view image is larger than the surrounding area in the first bird's eye view image.

### BRIEF DESCRIPTION OF DRAWINGS

FIG. 1 is a diagram illustrating a display system.

FIG. 2 is a diagram of a vehicle and a towed object.

FIG. 3 is a diagram showing a first bird's eye view image.

FIG. 4 is a diagram showing a second bird's eye view image.

FIG. 5 is a diagram showing a first bird's eye view image before transition to a second bird's eye view image.

FIG. 6 is a diagram showing a display screen displaying a bird's eye view image.

FIG. 7 is a diagram showing a second bird's eye view image.

FIG. 8 is a diagram showing a second bird's eye view image.

FIG. 9 is a flowchart of a display process.

FIG. 10 is a diagram showing a first bird's eye view image and a second bird's eye view image according to a modified example.

### DESCRIPTION OF EMBODIMENTS

To begin with, examples of relevant techniques will be described.

There is a surrounding monitoring device. The surrounding monitoring device generates a bird's eye view image showing the surrounding conditions of a towing vehicle and displays the generated image on a display device.

In the technology described above, the area around the vehicle shown in the bird's eye view image does not change depending on whether the vehicle is towing or not. Thus, the area in the bird's eye view image is not optimal in the towing state or the non-towing state. As a result, it is difficult for the user to check the surroundings of the vehicle in the towing state and the non-towing state. A controller of the present disclosure allows a user to easily check the surroundings of the vehicle in both the towing state and the non-towing state.

A controller disclosed herein includes a state determination unit and an image generation unit. The state determination unit is configured to determine whether a vehicle is in a towing state where the vehicle tows a towed object. The image generation unit is configured to generate a bird's eye view image from surrounding images of the surrounding area that are captured by multiple cameras, and display the bird's eye view image on a display. The bird's eye view image shows the vehicle and the surrounding area. The bird's eye view image includes a first bird's eye view image and a second bird's eye view image. The surrounding area in the second bird's eye view image is larger than the surrounding area in the first bird's eye view image. The image generation unit is further configured to display, on the display, the first bird's eye view image upon the state determination unit determining that the vehicle is not in the towing state, and display, on the display, the second bird's eye view image upon the state determination unit determining that the vehicle is in the towing state.

A display system disclosed herein is a display system used in a vehicle. The display system includes multiple cameras that are configured to capture a surrounding area of the vehicle, and a controller. The controller includes a state determination unit and an image generation unit. The state determination unit is configured to determine whether the vehicle is in a towing state where the vehicle tows a towed object. The image generation unit is configured to generate a bird's eye view image from surrounding images of the surrounding area that are captured by the multiple cameras, and display the bird's eye view image on a display. The bird's eye view image shows the vehicle and the surrounding area. The bird's eye view image includes a first bird's eye view image and a second bird's eye view image. The surrounding area in the second bird's eye view image is larger than the surrounding area in the first bird's eye view image. The image generation unit is further configured to display, on the display, the first bird's eye view image upon the state determination unit determining that the vehicle is not in the towing state, and display, on the display, the second bird's eye view image upon the state determination unit determining that the vehicle in the towing state.

A display method disclosed herein is used in a vehicle. The method includes acquiring surrounding images of a surrounding area around the vehicle that are captured by multiple cameras and determining whether the vehicle is in a towing state where the vehicle tows a towed object. The display method includes, upon determining that the vehicle is not in the towing state, generating a first bird's eye image of the vehicle and the surrounding area from the surrounding images, and displaying the first bird's eye view image on a display. The display method includes, upon determining that the vehicle is in the towing state, generating a second bird's eye view image of the vehicle and the surrounding area from the surrounding images, and displaying the second bird's eye view image on the display. The surrounding area in the second bird's eye view image is larger than the surrounding area in the first bird's eye view image.

According to the system and the method described above, when the vehicle is in the towing state, the first bird's eye view image is switched to the second bird's eye view image which shows a larger area of the surroundings of the vehicle compared to the first bird's eye view image. This makes it easier for the user to check the surroundings of the vehicle when the vehicle does not tow a towed object, and to check the surroundings of both the vehicle and the towed object when the vehicle tows the towed object. Thus, the user can easily check the surroundings of the vehicle depending on the towing state and the non-towing state.

The multiple embodiments disclosed in this specification adopt different technical means to achieve their respective purposes. The objectives, features, and effects disclosed in this specification will become clearer by referring to the subsequent detailed description and the accompanying drawings.

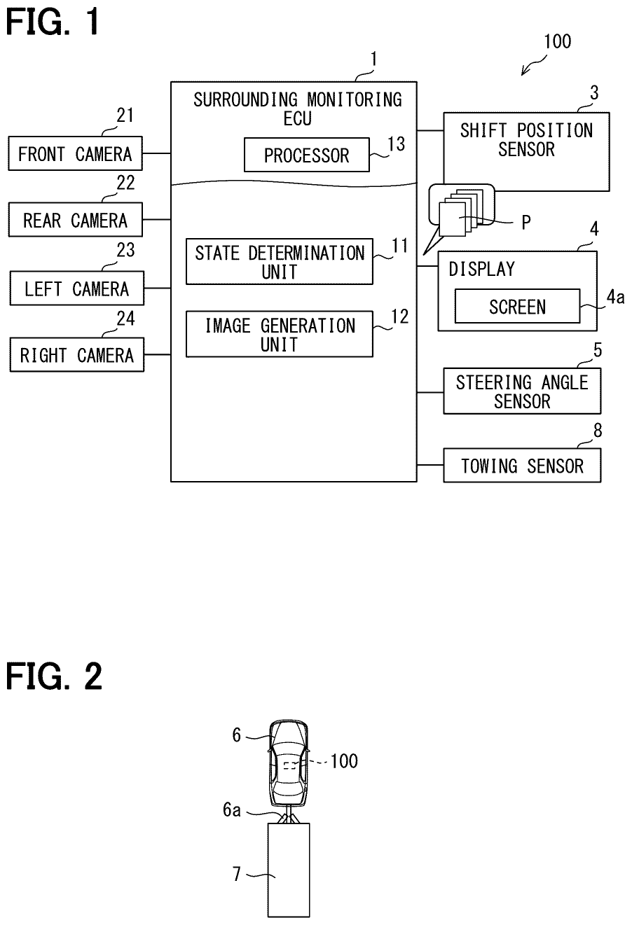

(Display system 100) A display system 100 shown in FIGS. 1 and 2 is mounted on a vehicle 6. The display system 100 is a system that captures images of the surroundings of the vehicle using multiple cameras 21 to 24, converts the captured images, and displays the converted image on a display 4. The vehicle 6 is, for example, a towing vehicle such as a pickup truck. A towing vehicle is a vehicle that tows a towed object 7 such as a boat trailer or a camping trailer. The vehicle 6 tows the towed object 7 by connecting a hitch 6a provided at the rear of the vehicle 6 to a coupling of the towed object 7.

The display system 100 includes the multiple cameras 21 to 24, a shift position sensor 3, a steering angle sensor 5, a towing sensor 8, a display 4, and a surrounding monitoring Electronic Control Unit (ECU) 1. The minimum components included in the display system 100 are the surrounding monitoring ECU 1 and the cameras 21 to 24.

The cameras 21 to 24 are mounted on the vehicle 6 with their imaging surfaces facing in different directions. The cameras 21 to 24 are configured to capture images of the surroundings of the vehicle 6. The front camera 21 is attached to the front end of the vehicle 6 with the imaging surface facing forward of the vehicle 6. The rear camera 22 is attached to the rear end of the vehicle 6 with the imaging surface facing rearward of the vehicle 6. The right camera 23 is attached near the right side mirror with the imaging surface facing to the right of the vehicle 6. The left camera 24 is attached near the left side mirror with the imaging surface facing to the left of the vehicle 6. Each of the cameras 21 to 24 captures images of the surroundings of the vehicle 6 to generate surrounding images, and sequentially outputs the surrounding images to the surrounding monitoring ECU 1. The surrounding image is an image that includes a part of the body of the vehicle 6. The surrounding image is an image that includes obstacles, other vehicles, pedestrians, and the like that exist around the vehicle 6.

The shift position sensor 3 detects a shift position of a shift lever. The steering angle sensor is a sensor that detects the steering angle. The towing sensor 8 is a sensor that detects whether the vehicle 6 is in a towing state. The towing state refers to a state in which the vehicle 6 tows the towed object 7. The non-towing state refers to a state in which the vehicle 6 does not tow the towed object 7. The towing sensor 8 is, for example, a circuit configured to detect when a towing button provided on the vehicle 6 is pressed. Alternatively, the towing sensor 8 may be a circuit configured to detect when the electrical system of the towed object 7 is connected to the vehicle 6.

The shift position sensor 3, the steering angle sensor 5, and the towing sensor 8 (hereinafter referred to as sensors) are configured to output signals indicating present values of target physical state quantities (i.e., detection results) to a communication line of a Local Area Network (LAN). The signals from the sensors are acquired by the surrounding monitoring ECU 1 and the like via the LAN.

The display 4 displays a predetermined image to the driver of the vehicle 6. The display 4 is a liquid crystal display, an organic EL display, or the like. The display 4 is a center display placed in the central region of the instrument panel. The display 4 notifies the driver of the vehicle 6 of predetermined information by displaying an image. The display 4 outputs visual information to the driver based on image data input from the surrounding monitoring ECU 1. The image data is data relating to a bird's eye view image P output by an image generation unit 12, which will be described later.

The display 4 has a touch panel function. The display 4 detects an operation by the user. The display 4 detects, for example, a touch operation, a swipe operation, and the like, performed by the user on a display screen 4a. The display 4 detects information input by the user. The display 4 detects size information of the towed object 7 input by the user. The display 4 transmits the detected user operation or the size information input by the user to the surrounding monitoring ECU 1.

(Surrounding Monitoring ECU 1) The surrounding monitoring ECU 1 performs a display process of generating a bird's eye view image P from the surrounding images obtained from the multiple cameras 21 to 24, and displaying the bird's eye view image P on the display 4. The surrounding monitoring ECU 1 switches the bird's eye view image displayed on the display 4 depending on whether the vehicle is in the towing state or not.

The timing at which the surrounding monitoring ECU 1 performs the display process (hereinafter, the display timing) is, for example, immediately after the engine is started. Alternatively, the display timing may be when a view button provided on the vehicle 6 is pressed. The display timing may be when the shift position is switched to the reverse position. The display timing may be set arbitrarily.

The surrounding monitoring ECU 1 mainly includes a microcontroller which includes a processor 13, a memory, an I/O, and a bus connecting these components. The surrounding monitoring ECU 1 corresponds to a controller. The surrounding monitoring ECU 1 executes various processes by executing control programs stored in the memory with the processor 13.

The surrounding monitoring ECU 1 includes a state determination unit 11 and an image generation unit 12. The state determination unit 11 determines the state of the vehicle 6 based on the information acquired from the sensors. The state determination unit 11 determines, based on a signal from the shift position sensor 3, whether the shift lever is in the forward position or the reverse position. The state determination unit 11 determines the steering angle of the vehicle 6 based on a signal from the steering angle sensor 5.

The state determination unit 11 determines whether the vehicle 6 is in the towing state in which the vehicle 6 tows the towed object 7. The state determination unit 11 determines whether the vehicle 6 is in the towing state based on a signal from the towing sensor 8. Alternatively, the state determination unit 11 determines whether the vehicle 6 is in the towing state by image recognition. For example, when the towed object 7 is detected based on the surrounding image captured by the rear camera 22, the state determination unit 11 determines that the vehicle is in the towing state. The state determination unit 11 may determine whether the vehicle 6 is in the towing state by a method other than image recognition. When it is determined that the vehicle 6 is not in the towing state, the state determination unit 11 determines that the vehicle 6 is in the non-towing state.

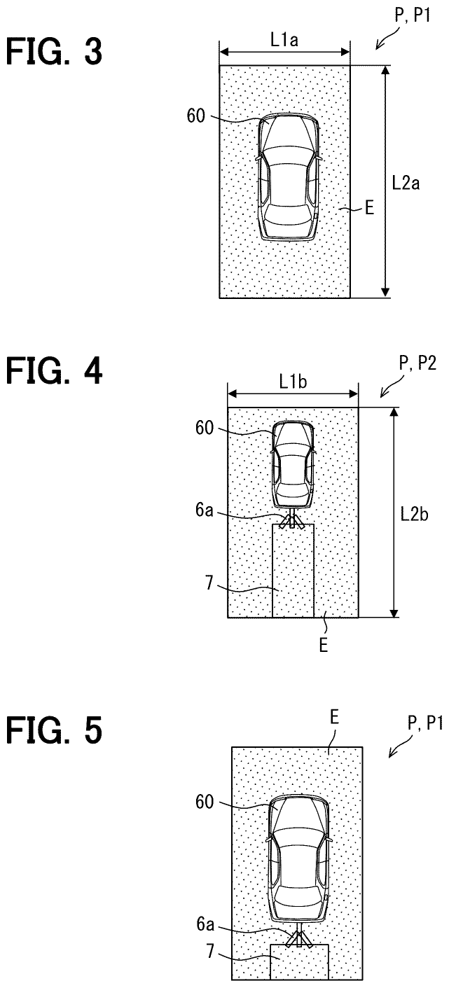

The image generation unit 12 generates a bird's eye view image P from the surrounding images of the surrounding area captured by the cameras 21 to 24. The bird's eye view image P is an image of the vehicle 6 and the surrounding area viewed above the vehicle 6. The image generation unit 12 transmits image data including the generated bird's eye view image P to the display 4. The image generation unit 12 controls the display 4 to display the bird's eye view image P. As shown in FIG. 3 and other figures, the bird's eye view image P includes surrounding area E that is an area around the vehicle 6. As shown in FIG. 4, the surrounding area E also includes the towed object 7 and the area around the towed object 7. The surrounding area E is shown by hatching in FIGS. 3, 4, and 5.

The image generation unit 12 generates the bird's eye view image P based on the surrounding images and a vehicle image 60 which shows the vehicle 6. The vehicle image 60 is stored in a memory in advance. The image generation unit 12 acquires the vehicle image 60 from the memory. The bird's eye view image P is a bird's eye view showing the positional relationship between the vehicle 6 and the surroundings of the vehicle 6 as seen from a virtual viewpoint above the vehicle 6.

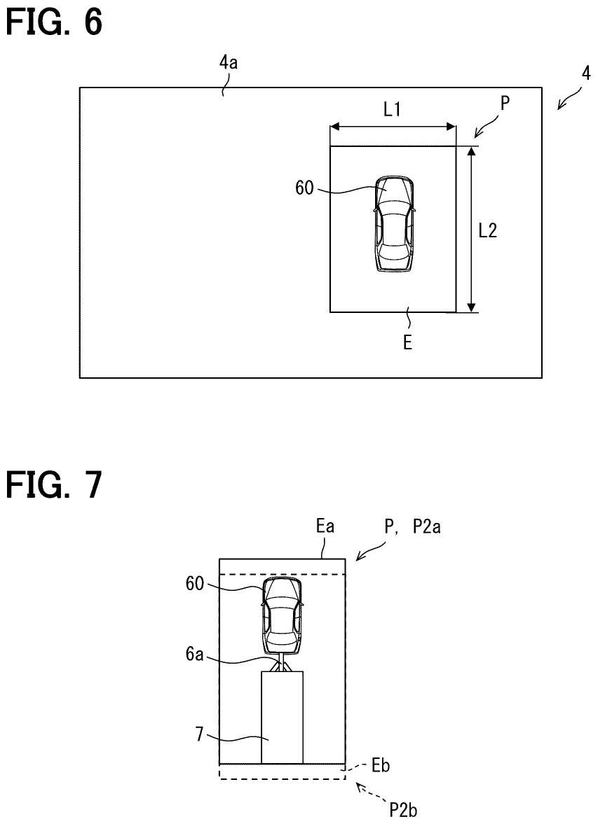

The bird's eye view image P is displayed in a part of the display screen 4a as shown in FIG. 6. On the display screen 4a, a navigation screen or the like may be displayed in the area other than the bird's eye view image P. The position where the bird's eye view image P is displayed on the display screen 4a may be arbitrarily set. The image size of the bird's eye view image P is set to a fixed value in this embodiment. The image size of the bird's eye view P is defined by a width L1 and a height L2. The width L1 and the height L2 of the bird's eye view image P are set to constant values, respectively.

Here, a first bird's eye view image P1 and a second bird's eye view image P2 included in the bird's eye view image P will be described mainly with reference to FIGS. 3, 4, and 5. FIG. 1 will also be referred to as appropriate. The image generation unit 12 switches the bird's eye view image P displayed on the display 4 depending on whether the vehicle 6 is in the non-towing state or the towing state. When the vehicle 6 is in the non-towing state, the image generation unit 12 generates the first bird's eye view image P1 (FIG. 3). When the vehicle 6 is in the towing state, the image generation unit 12 generates the second bird's eye view image P2 in which an area of the surrounding area E is larger than an area in the first bird's eye view image P1 (FIG. 4). Then, the image generation unit 12 switches the bird's eye view image P displayed on the display 4 to the second bird's eye view image P2. The first bird's eye view image P1 and the second bird's eye view image P2 have the same image size. That is, the width L1a of the first bird's eye view image P1 is the same as the width L1b of the second bird's eye view image P2. The height L2a of the first bird's eye view image P1 is the same as the height L2b of the second bird's eye view image P2.

The first bird's eye view image P1 is a bird's eye view seen from a first virtual viewpoint above the vehicle 6 (FIG. 3). In the first bird's eye view image P1, the vehicle image 60 is at the center of the image.

The second bird's eye view image P2 is a bird's eye view seen from a second virtual viewpoint that is higher than the first virtual viewpoint (FIG. 4). The surrounding area E in the second bird's eye view image P2 is larger than the surrounding area E in the first bird's eye view image P1. In other words, an area of the surrounding area E in the second bird's eye view image P2 is larger than an area of the surrounding area E in the first bird's eye view image P1.

In the width and height directions of the image, the surrounding area E in the second bird's eye view image P2 is larger than the surrounding area E in the first bird's eye view image P1. Particularly in the width direction, the surrounding area E in the second bird's eye view image P2 is larger than the surrounding area E in the first bird's eye view image P1.

The first bird's eye view image P1 and the second bird's eye view image P2 have the same image size. That is, the first bird's eye view image is a closer view compared to the second bird's eye view image.

The image generation unit 12 determines the surrounding area E in the second bird's eye view image P2 based on size information, which is information about the size of the towed object 7. The image generation unit 12 increases the surrounding area E in the second bird's eye view image P2 as the size of the towed object 7 is increased. Contrary, the smaller the size of the towed object 7, the smaller the surrounding area E in the second bird's eye view image P2.

The image generation unit 12 generates the second bird's eye view image P2 so that the rear end of the towed object 7 is included within the second bird's eye view image P2. The position of the rear end of the towed object 7 is calculated based on the size information of the towed object 7. The image generation unit 12 determines the surrounding area E in the second bird's eye view image P2 so that the towed object 7 is entirely included within the second bird's eye view image P2 even when the steering wheel is turned.

The image generation unit 12 acquires information input by the user as size information. The image generation unit 12 causes the display 4 to display a message that encourages the user to input size information. The size information is information about the size of the towed object 7, such as the overall length, overall width, and overall height of the towed object 7. The size information may be the type of the towed object 7. The image generation unit 12 may obtain the size information by image recognition using the surrounding images.

The image generation unit 12 determines the surrounding area E in the second bird's eye view image P2 based on an operation by the user. The image generation unit 12 causes the display 4 to display a screen for setting the size of the surrounding area E in the second bird's eye view image P2. The image generation unit 12 displays, for example, a scroll bar as the screen for the setting. The image generation unit 12 adjusts the surrounding area E shown in the second bird's eye view image P2, based on the operation by the user for the setting. The image generation unit 12 may display selection buttons such as large, medium, and small on the display 4 in addition to the scroll bar.

When the vehicle 6 is in the towing state, the image generation unit 12 displays the second bird's eye view image P2. At first in this case, the image generation unit 12 may cause the display 4 to display the first bird's eye view image P1. Then, the image generation unit 12 may display an animation in which the image displayed on the display 4 is gradually switched to the second bird's eye view image P2. FIG. 5 is a diagram showing the vehicle 6 in the towing state. The image generation unit 12 may display, on the display 4, an animation in which the first bird's eye view image P1 shown in FIG. 5 is gradually switched to the second bird's eye view image P2 shown in FIG. 4.

The image generation unit 12 performs an adjusting process to alter the surrounding area E in the second bird's eye view image P2 depending on whether the shift lever provided on the vehicle 6 is in the forward position or the reverse position.

When the shift lever is in the forward position, the image generation unit 12 adjusts the surrounding area Ea (solid line in FIG. 7) shown in the second bird's-eye view image P2a to be shifted towards the front side of the vehicle 6 compared to when the shift lever is in the reverse position. On the other hand, when the shift lever is in the reverse position, the image generation unit 12 adjusts the surrounding area Eb (dashed line in FIG. 7) in the second bird's eye view image P2b to be shifted towards the rear side of the vehicle 6 compared to when the shift lever is in the forward position.

The surrounding area Ea in the second bird's eye view image P2a includes a larger forward area of the vehicle 6 compared to the surrounding area Eb in the second bird's eye view image P2b. Thus, the second bird's eye view image P2a makes it easier to check the area ahead of the vehicle 6 than the second bird's eye view image P2b. The surrounding area Eb in the second bird's eye view image P2b includes a larger rear area behind the vehicle 6 compared to the surrounding area Ea in the second bird's eye view image P2a. Thus, the second bird's eye view image P2b makes it easier to check the surroundings of the towed object 7 than the second bird's eye view image P2a.

The image generation unit 12 determines whether to perform the adjusting process based on an operation by the user. The image generation unit 12 causes the display 4 to display a screen for setting the adjusting process. The image generation unit 12 displays, for example, a button for selecting whether to turn on or off the adjusting process. Based on the operation by the user at that time, the image generation unit 12 determines whether to perform the adjusting process.

The image generation unit 12 changes the surrounding area E in the second bird's eye view image P2 in accordance with the steering angle of the vehicle 6. The image generation unit 12 adjusts the surrounding area E in the second bird's eye view image P2 to include more of the area in the direction in which the vehicle 6 turns.

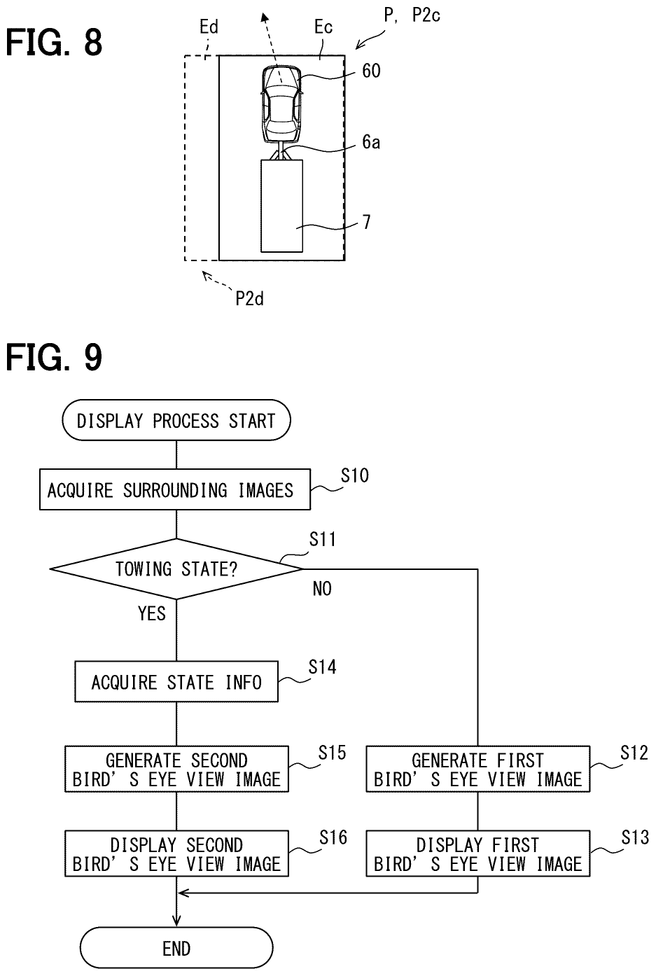

When the steering angle of the vehicle 6 is 0 degree, the image generation unit 12 adjusts the surrounding area Ec so that the surrounding area Ec in the second bird's eye view image P2c includes both the left and right areas of the vehicle 6 to the same extent (solid lines in FIG. 8). On the other hand, when the steering angle of the vehicle 6 is equal to or greater than a predetermined value and the vehicle 6 is about to turn left, the image generation unit 12 adjusts the surrounding area Ed so that the surrounding area Ed in the second bird's eye view image P2d includes more of the area to the left of the vehicle 6 (dashed line in FIG. 8).

The surrounding monitoring ECU 1 corresponds to a parking assistance ECU that assists or autonomously executes driving control for parking. The surrounding monitoring ECU 1 is not limited to a parking assistance ECU, and may be an autonomous driving ECU having an autonomous driving function.

(Flowchart of Display Process) The surrounding monitoring ECU 1 starts when the ignition switch of the vehicle 6 is turned on, and ends its processing when the ignition switch is turned off. The display process shown in FIG. 9 starts at the display timing while the surrounding monitoring ECU 1 is running. The execution of the processes from S10 to S16 by the processor 13 corresponds to the execution of a display method.

In S10, the image generation unit 12 acquires surrounding images from the multiple cameras 21 to 24. In S11, the state determination unit 11 determines whether the vehicle 6 is in the towing state. If the answer is No in S11, the process proceeds to S12.

In S12, the image generation unit 12 generates a first bird's eye view image P1. In S13, the image generation unit 12 transmits the first bird's eye view image P1 to the display 4 as image data. The image generation unit 12 controls the display 4 to display the first bird's eye view image P1. The display 4 displays the first bird's eye view image P1.

If the answer is Yes in S11, the process proceeds to S14. If the execution of the adjusting process is set to ON, the state determination unit 11 determines in S14 whether the shift lever is in the forward state or the reverse state based on the signals from the shift position sensor 3. The state determination unit 11 determines the steering angle of the vehicle 6 based on a signal from the steering angle sensor 5.

In S15, the image generation unit 12 generates a second bird's eye view image P2. At this time, if the image generation unit 12 has the size information in advance, the image generation unit 12 determines the surrounding area E in the second bird's eye view image P2 based on the size information. In addition, the image generation unit 12 adjusts the surrounding area E in the second bird's eye view image P2 depending on whether the shift lever is in the forward position or the reverse position.

Furthermore, the image generation unit 12 adjusts the surrounding area E in the second bird's eye view image P2 in accordance with the steering angle of the vehicle 6. The surrounding area E is adjusted as described above, and the second bird's eye view image P2 is generated.

In S16, the image generation unit 12 transmits image data including the second bird's eye view image P2 to the display 4. The image generation unit 12 controls the display 4 to display the second bird's eye view image P2. The display 4 displays the second bird's eye view image P2.

When the execution of the adjusting process is set to OFF, the process of determining the state of the shift lever in S14 may be omitted. Similarly, the adjusting process in S15 may be omitted.

(Overview of Embodiments) According to this embodiment, when the vehicle 6 is in the towing state, the image is switched from the first bird's eye view image P1 to the second bird's eye view image P2, which shows larger surrounding area of the vehicle 6 compared to the first bird's eye view image P1. This makes it easier for the user to check the situation around the vehicle 6 when the vehicle 6 does not tow the towed object, and makes it easier for the user to check the situation around the vehicle 6 and the towed object 7 when the vehicle 6 is towing the towed object. Thus, the user can easily check the situations around the vehicle 6 for each of the towing state and the non-towing state.

The image generation unit 12 determines the surrounding area E in the second bird's eye view image P2 based on size information, which is information about the size of the towed object 7. As a result, the surrounding area E in the second bird's eye view image P2 can be an appropriate range based on the size of the towed object 7. This improves the visibility for the user.

The image generation unit 12 acquires information input by the user as size information. The surrounding area E in the second bird's eye view image P2 can be an appropriate range based on the size of the towed object 7. This improves the visibility for the user.

The image generation unit 12 determines the surrounding area E in the second bird's eye view image P2 based on an operation by the user. This makes it possible to determine the surrounding area E in the second bird's eye view image P2 according to the user's preferences.

The image generation unit 12 performs the adjusting process to alter the surrounding area E in the second bird's eye view image P2 depending on whether the shift lever provided on the vehicle 6 is set to the forward position or the reverse position. Thus, the optimal surrounding area E is displayed in both the forward moving or reverse moving state. As a result, the visibility for the user is improved.

The image generation unit 12 determines whether to perform the adjusting process based on an operation by the user. This allows the user to decide whether to perform the adjusting process according to their preference.

The image generation unit 12 adjusts the surrounding area E in the second bird's eye view image P2 in accordance with the steering angle of the vehicle 6. Since the surrounding area E is expanded in the direction that needs to be checked, the visibility for the user is improved.

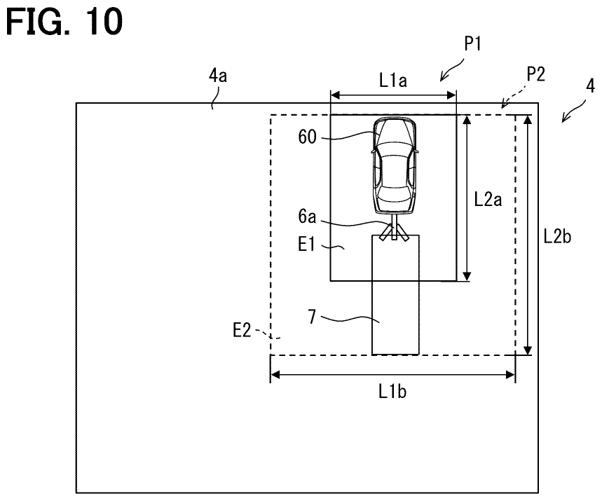

(Modifications) The first bird's eye view image P1 and the second bird's eye view image P2 are views seen from different virtual viewpoints, but the present disclosure is not limited to this. FIG. 10 shows the first bird's eye view image P1 (solid line) and the second bird's eye view image P2 (dashed line) displayed on the display screen 4a. The first bird's eye view image P1 and the second bird's eye view image P2 are created as bird's eye views seen from the same virtual viewpoint.

In the above embodiment, the image size of the bird's eye view image P is the same regardless of whether the vehicle 6 is in the towing state or the non-towing state. In this modification, the image size of the bird's eye view image P is changed depending on whether the vehicle 6 is in the towing state or the non-towing state. The image size of the first bird's eye view image P1 is smaller than the image size of the second bird's eye view image P2. As a result, the proportion of the bird's eye view image P that occupies the display screen 4a differs depending on the towing state or the non-towing state. The width L1a of the first bird's eye view image P1 is smaller than the width L1b of the second bird's eye view image P2. The height L2a of the first bird's eye view image P1 is smaller than the height L2b of the second bird's eye view image P2.

Although the image generation unit 12 is configured to adjust the surrounding area E in the second bird's eye view image P2 in accordance with the steering angle of the vehicle 6, the present disclosure is not limited to this. The image generation unit 12 may be configured not to adjust the surrounding area E in the second bird's eye view image P2 in accordance with the steering angle of the vehicle 6.

1. A controller comprising:
a state determination unit configured to determine whether a vehicle is in a towing state where the vehicle tows a towed object; and
an image generation unit configured to:
generate a bird's eye view image from surrounding images of a surrounding area of the vehicle that are captured by multiple cameras, the bird's eye view image showing the vehicle and the surrounding area; and
display the bird's eye view image on a display, wherein
the bird's eye view image includes a first bird's eye view image and a second bird's eye view image,
the surrounding area in the second bird's eye view image is larger than the surrounding area in the first bird's eye view image, and
the image generation unit is further configured to:
display, on the display, the first bird's eye view image upon the state determination unit determining that the vehicle is not in the towing state; and
display, on the display, the second bird's eye view image upon the state determination unit determining that the vehicle is in the towing state.

2. The controller according to claim 1, wherein
the image generation unit is further configured to determine the surrounding area in the second bird's eye view image based on size information of the towed object.

3. The controller according to claim 2, wherein
the image generation unit is further configured to acquire the size information input by a user.

4. The controller according to claim 1, wherein
the image generation unit is further configured to determine the surrounding area in the second bird's eye view image based on an operation by a user.

5. The controller according to claim 1, wherein
the image generation unit is further configured to perform an adjusting process to adjust the surrounding area in the second bird's view image depending on a forward position or a reverse position of a shift lever of the vehicle.

6. The controller according to claim 5, wherein
the image generation unit is further configured to determine whether to perform the adjusting process based on an operation by a user.

7. The controller according to claim 1, wherein
the image generation unit is further configured to adjust the surrounding area in the second bird's eye view image based on a steering angle of the vehicle.

8. A display system used in a vehicle, the display system comprising:
multiple cameras that are configured to capture a surrounding area of the vehicle; and
a controller, wherein
the controller includes:
a state determination unit configured to determine whether the vehicle is in a towing state where the vehicle tows a towed object; and
an image generation unit configured to:
generate a bird's eye view image from surrounding images of the surrounding area that are captured by the multiple cameras, the bird's eye view image showing the vehicle and the surrounding area; and
display the bird's eye view image on a display,
the bird's eye view image includes a first bird's eye view image and a second bird's eye view image,
the surrounding area in the second bird's eye view image is larger than the surrounding area in the first bird's eye view image, and
the image generation unit is further configured to:
display, on the display, the first bird's eye view image upon the state determination unit determining that the vehicle is not in the towing state; and
display, on the display, the second bird's eye view image upon determining the state determination unit determining that the vehicle is in the towing state.

9. A display method used in a vehicle, the display method comprising:
acquiring surrounding images of a surrounding area around the vehicle that are captured by multiple cameras;
determining whether the vehicle is in a towing state where the vehicle tows a towed object;
upon determining that the vehicle is not in the towing state:
generating a first bird's eye image of the vehicle and the surrounding area from the surrounding images; and
displaying the first bird's eye view image on a display; and
upon determining that the vehicle is in the towing state:
generating a second bird's eye view image of the vehicle and the surrounding area from the surrounding images, the surrounding area in the second bird's eye view image being larger than the surrounding area in the first bird's eye view image; and
displaying the second bird's eye view image on the display.

10. The display method according to claim 9 executed by at least one processor.
